(19) United States
(12) Patent Application Publication
(10) Pub. No.: US 2019/0199622 A1
(43) Pub. Date: Jun. 27, 2019

(54) DATA PACKET FORWARDING UNIT IN A DATA TRANSMISSION NETWORK

(71) Applicant: HUAWEI TECHNOLOGIES CO., LTD., Shenzhen (CN)

(72) Inventors: Ishan VAISHNAVI, Munich (DE); David Perez, Shenzhen (CN); Qing Wei, Munich (DE)

(73) Assignee: HUAWEI TECHNOLOGIES CO., LTD., Shenzhen (CN)

(21) Appl. No.: 16/285,943

(22) Filed: Feb. 26, 2019

Related U.S. Application Data
(63) Continuation of application No. PCT/EP2016/070159, filed on Aug. 26, 2016.

(51) Int. Cl. H04L 12/721; H04L 12/947

(52) U.S. Cl. CPC H04L 45/38; H04L 41/20; H04L 49/25

(57) ABSTRACT

This embodiments of the invention relates to a data packet forwarding unit (202) configured to forward data packets within a data transmission network on the basis of data packet forwarding rules, wherein the data transmission network comprises a control plane and a separate data plane. The data packet forwarding unit (202) comprises a storage unit (202b) configured to store at least one of data transmission profiles, wherein each data transmission profile comprises at least one data packet forwarding rule, and a processor (202a) configured to select a data transmission profile from the at least one data transmission profiles and to forward data packets within the data transmission network on the basis of the at least one data packet forwarding rule of the selected data transmission profile.

### CROSS-REFERENCE TO RELATED APPLICATIONS

This application is a continuation of International Application No. PCT/EP2016/070159, filed on Aug. 26, 2016, the disclosure of which is hereby incorporated by reference in its entirety.

### TECHNICAL FIELD

In general, the present embodiments of the invention relates to data transmission networks. More specifically, the present embodiments of the invention relates to a data packet forwarding unit in a data transmission network.

### BACKGROUND

In conventional data transmission networks, network forwarding elements like routers and switches contain data plane (D-plane) functions as well as control plane (C-plane) functions. Software defined networking (SDN) is an approach to network design and management that separates the control plane from the forwarding plane of the network and, thus, enables their independent handling. The control plane can be centralized so that the development of control plane protocols is simpler and faster. Software defined networking defines network devices as flow treatment devices, denoted as switches. On the basis of these switches, SDN can concentrate classical management and control plane intelligence in one logical device, which is also called a controller (also referred to as SDN controller). The common abstraction and the locally available data make developing control and management applications easier. Due to the centralization of the control plane, the network functions are moved to the controller, e.g. they can be implemented as control applications (cAPPs) running on the controller. For example, in routing, conventional switches run both link state distribution protocols and route (path) computation, while SDN enabled switches only distribute their link states to the controller and the controller performs path computation. These paths are used in switches by installing appropriate flow rules.

FIG. 1 shows an illustration of a SDN architecture 100. In this architecture, the SDN controller 108 is one of the key components of a SDN network. By means of a so-called southbound application programming interface (i.e. Southbound API), the SDN controller 108 can communicate with the network elements in the infrastructure layer, namely a plurality of switches 102, and relay the necessary data to and from these switches 102 to build a centralized view of the network state. By means of the so-called “Northbound API”, the SDN controller 108 can expose the centralized view to a plurality of SDN control applications 104a-c (i.e. SDN cAPPs running on the SDN controller 108), enabling these control applications 104a-c to execute their logic and manipulate the network state. The southbound API can be implemented using the OpenFlow protocol. The OpenFlow switch abstraction is the key assumption that the protocol makes and the concepts of a flow and a flow table lie at the heart of that abstraction. A flow is essentially any sequence of packets which share a common set of layer 2-layer 3 (L2-L3) protocol bits (e.g. packets destined to the same internet protocol (IP) address), while a flow table of a switch is a collection of all flows relevant to that switch. Each flow entry in a flow table (herein also referred to as a data packet forwarding rule) is associated with a set of actions which should be executed when an input packet is matched to the flow entry. The communication channel between the SDN controller 108 and a switch 102 is usually called a control channel. It can be logically implemented as a transport layer security (TLS) or transmission control protocol (TCP) connection between the SDN controller 108 and the switch 102. Therefore, the term control connection is also used with the same meaning as control channel. Physically, control connections can be implemented in-band, in which case other switches can relay packets of the control connections of other switches, or out-of-band, in which case a separate physical network is used.

The separation of the control plane and data plane implies that the control plane needs to program the data plane for each and every connection that is set up in the network. A lot of connections are identical in nature. For example, a basic protocol connection like TCP always requires the setup of the TCP path in both directions together with the setup of the internet control message protocol (ICMP) path in both directions. Instead, the data plane may know beforehand the set of rules that need to be installed by the control plane for a TCP connection. The control plane instead of deploying four separate rules may only indicate that it needs a TCP connection from 10.10.1.4 to 10.1.20.5. The data plane automatically takes care of the rest.

With the realization of “slices” this behaviour will become more relevant. Slices are the separation either physical, architectural, or just in the visibility of the network. Each slice owner can only see his or her slice and does not see the actual underlying support framework or infrastructure. The connections within each slice fall into the same service category and are foreseen to have significant similarity among themselves, while the number of rules to be installed will become more complex.

P4 (Bosshart et al., “P4: programming protocol-independent packet processors” SIGCOMM Comput. Commun. Rev. 44, 3 Jul. 2014, 87-95) is a programming language designed to allow programming of packet forwarding data planes. P4 allows a switch to specify a forwarding protocol by itself in the field, such as different packet parser, different matching table and different types of action. It also supports the selection of a certain action from a list using some limited dynamic states. This provides certain flexibility for the flow rules at a switch.

However, although the forwarding protocol can be freely defined, the P4 programming language does not tackle the issue of reducing the number of flow rules for the specific protocol. Moreover, the complete set of rules for one protocol still needs to be defined.

In light of the above, there is a need for an improved data packet forwarding unit, controller and corresponding method in a data transmission network.

### SUMMARY

It is an object of the embodiment of the invention to provide an improved data packet forwarding unit, controller and corresponding method in a data transmission network.

The foregoing and other objects are achieved by the subject matter of the independent claims. Further implementation forms are apparent from the dependent claims, the description and the figures.

According to a first aspect the embodiments of the invention relates to a data packet forwarding unit configured to forward data packets within a data transmission network on the basis of data packet forwarding rules, wherein the data transmission network comprises a control plane and a separate data plane. The data packet forwarding unit comprises a storage unit configured to store at least one data transmission profiles, wherein each data transmission profile comprises at least one data packet forwarding rules, and a processor configured to select a data transmission profile from the at least one data transmission profiles and to forward data packets within the data transmission network on the basis of the at least one data packet forwarding rule of the selected data transmission profile.

Thus, an improved data packet forwarding unit in a data transmission network is provided. The data packet forwarding unit according to the first aspect of the embodiments of the invention allows substantially reducing the signaling required between the data packet forwarding unit and a controller for implementing data packet forwarding rules on the data packet forwarding unit. Meanwhile, the run time processing complexity at the controller is reduced by defining one control message to indicate the selected data transmission profile and related parameters instead of defining several control messages to indicate all the data packet forwarding rules of the selected data transmission profile.

In a first possible implementation form of the data packet forwarding unit according to the first aspect as such, the processor is configured to select the data transmission profile from the at least one data transmission profiles on the basis of a first control message from a controller of the data transmission network. In the first implementation form the data packet forwarding unit can install the profile which may be comprised of multiple rules via a single command from the controller. This reduces the control message flow from controller to the forwarding unit.

In a second possible implementation form of the data packet forwarding unit according to the first implementation form of the first aspect, the processor is configured to extract an identifier from the first control message, wherein the identifier identifies the selected data transmission profile.

In a third possible implementation form of the data packet forwarding unit according to the first or second implementation form of the first aspect, the processor is further configured to extract one or more parameters from the first control message to be applied to the selected data transmission profile. In the third implementation form each profile can be customized to certain parameters.

In a fourth possible implementation form of the data packet forwarding unit according to the first aspect as such or any one of the first to third implementation form thereof, the processor is configured to add a data packet forwarding rule to at least one of the data transmission profiles of the at least one data transmission profiles or to modify or remove a data packet forwarding rule of at least one of the data transmission profiles of the at least one data transmission profiles on the basis of a second control message. The fourth implementation from enables flexibility.

In a fifth possible implementation form of the data packet forwarding unit according to the first aspect as such or any one of the first to fourth implementation form thereof, the processor is configured to add a data transmission profile to the at least one data transmission profiles on the basis of a third control message. The fifth implementation form enables programming new profile to the switch.

In a sixth possible implementation form of the data packet forwarding unit according to the first aspect as such or any one of the first to fifth implementation form thereof, the data packet forwarding unit is a switch implemented in accordance with the OpenFlow standard, wherein the at least one data packet forwarding rule is stored in the storage unit in the form of a separate database, a flow table, a group table or a meter table.

In a seventh possible implementation form of the data packet forwarding unit according to the first aspect as such or any one of the first to sixth implementation form thereof, the data transmission network is a software defined network, wherein the controller of the data transmission network is a SDN controller.

In an eighth possible implementation form of the data packet forwarding unit according to the first aspect as such or any one of the first to fifth implementation form thereof, the selected data transmission profile comprises a root data packet forwarding rule and at least one dependent data packet forwarding rule, wherein the processor is configured to activat or modify the at least one dependent data packet forwarding rule in response to the root data packet forwarding rule being used by the data packet forwarding unit. The eighth implementation form enables lazy loading of flow rules reducing the number of active rules in the forwarding element saving on expensive storage unit, such as TCAM memory, when flows are not being used.

In a ninth possible implementation form of the data packet forwarding unit according to the first aspect as such or any one of the first to eighth implementation form thereof, the data packet forwarding unit is configured to inform the controller of the data transmission network about the at least one data transmission profiles stored in the storage unit of the data packet forwarding unit. The ninth implementation form provides initial handshake enabling common identifiers.

According to a second aspect the embodiments of the invention relates to a controller configured to control forwarding of data packets within a data transmission network by providing data packet forwarding rules to a data packet forwarding unit, wherein the data transmission network comprises a control plane and a separate data plane. The controller comprises a processor configured to generate a first control message for the data packet forwarding unit, wherein the first control message instructs the data packet forwarding unit to select a data transmission profile from at least one data transmission profiles of the data packet forwarding unit.

Thus, an improved controller in a data transmission network is provided. The controller according to the second aspect of the embodiments of the invention allows substantially reducing the signaling required between a data packet forwarding unit and the controller for implementing data packet forwarding rules on the data packet forwarding unit.

In a first possible implementation form of the controller according to the second aspect as such, the processor is configured to generate a second control message for the data packet forwarding unit, wherein the second control message instructs the data packet forwarding unit to add a data packet forwarding rule to at least one of the data transmission profiles of the at least one data transmission profiles.

In a second possible implementation form of the controller according to the second aspect as such or the first implementation form thereof, the processor is configured to generate a third control message for the data packet forwarding unit, wherein the third control message instructs the data packet forwarding unit to add a data transmission profile to the at least one data transmission profiles.

In a third possible implementation form of the controller according to the second aspect as such or the first or second implementation form thereof, the controller comprises a storage unit configured to store information about the at least one data transmission profiles of the data packet forwarding unit.

According to a third aspect the embodiments of the invention relates to a method of operating a data packet forwarding unit configured to forward data packets within a data transmission network on the basis of data packet forwarding rules, wherein the data transmission network comprises a control plane and a separate data plane. The method comprises a step of selecting a data transmission profile from at least one data transmission profiles stored in a storage unit of the data packet forwarding unit, wherein the data transmission profile comprises at least one data packet forwarding rule, and a step of forwarding data packets within the data transmission network on the basis of one of the at least one data packet forwarding rule of the selected data transmission profile.

The method according to the third aspect of the embodiments of the invention can be performed by the data packet forwarding unit according to the first aspect of the embodiments of the invention. Further features and implementation forms of the method according to the third aspect of the embodiments of the invention result directly from the functionality of the data packet forwarding unit according to the first aspect of the embodiments of the invention and its different implementation forms.

According to a fourth aspect, the embodiments of the invention relates to a computer program comprising program code for performing the method of the third aspect when executed on a computer.

### BRIEF DESCRIPTION OF DRAWINGS

Further embodiments of the invention will be described with respect to the following figures, wherein:

FIG. 1 shows a schematic diagram of an exemplary SDN architecture;

FIG. 2 shows a schematic diagram of a SDN architecture including a data packet forwarding unit according to an embodiment;

FIG. 3 shows a schematic diagram illustrating an interaction between a controller according to an embodiment and a data packet forwarding unit according to an embodiment;

FIG. 4 shows a schematic diagram illustrating an interaction between a controller according to an embodiment and a data packet forwarding unit according to an embodiment;

FIG. 5 shows a schematic diagram of a process to provide a data transmission profile to a data packet forwarding unit according to an embodiment;

FIG. 6 shows a schematic diagram of a data packet forwarding unit according to an embodiment and a controller according to an embodiment;

FIG. 7 shows a schematic diagram illustrating the concept of dynamic flow rules implemented in a data packet forwarding unit according to an embodiment.

FIG. 8 shows a schematic diagram of a data packet forwarding unit according to an embodiment and a controller according to an embodiment; and

FIG. 9 shows a schematic diagram of a method of operating a data packet forwarding unit configured to forward data packets within a data transmission network according to an embodiment.

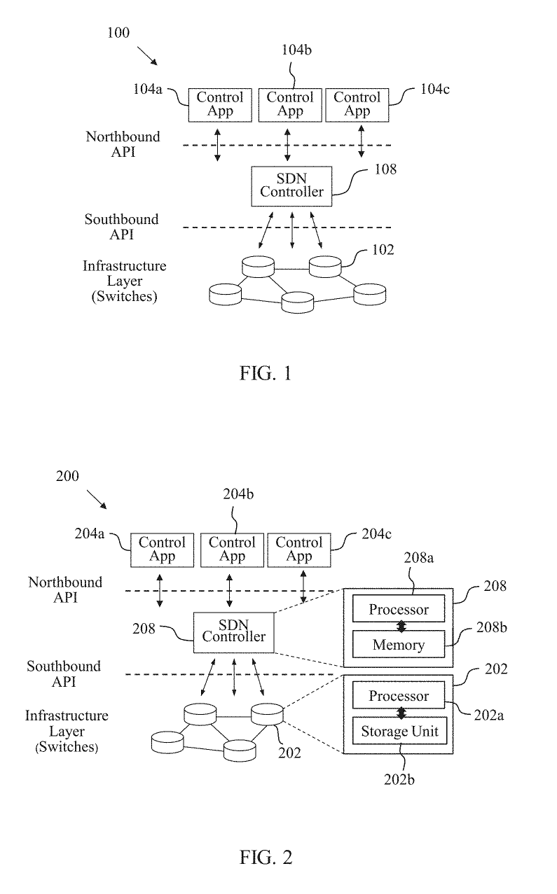

In the figures, identical reference signs will be used for identical or functionally equivalent features.

### DESCRIPTION OF EMBODIMENTS

In the following description, reference is made to the accompanying drawings, which form part of the disclosure, and in which are shown, by way of illustration, specific aspects in which the present embodiments of the invention may be placed. It will be appreciated that the embodiments of the invention may be placed in other aspects and that structural or logical changes may be made without departing from the scope of the embodiments of the invention. The following detailed description, therefore, is not to be taken in a limiting sense, as the scope of the embodiments of the invention is defined by the appended claims.

For instance, it will be appreciated that a disclosure in connection with a described method will generally also hold true for a corresponding device or system configured to perform the method and vice versa. For example, if a specific method step is described, a corresponding device may include a unit to perform the described method step, even if such unit is not explicitly described or illustrated in the figures.

Moreover, in the following detailed description as well as in the claims, embodiments with functional blocks or processing units are described, which are connected with each other or exchange signals. It will be appreciated that the embodiments of the invention also covers embodiments which include additional functional blocks or processing units that are arranged between the functional blocks or processing units of the embodiments described below.

Finally, it is understood that the features of the various exemplary aspects described herein may be combined with each other, unless specifically noted otherwise.

FIG. 2 shows a schematic diagram of a SDN architecture 200 including a data packet forwarding unit 202 according to an embodiment and a controller 208 according to an embodiment. In an embodiment, the data packet forwarding unit 202 is a switch implemented in accordance with the OpenFlow standard. In addition to the switch 202 FIG. 2 shows a couple of additional switches, which in an embodiment are implemented as the switch 202. In an embodiment, the controller 208 is a SDN controller.

The data packet forwarding unit 202 is configured to forward data packets within a data transmission network on the basis of data packet forwarding rules, wherein the data transmission network comprises a control plane and a separate data plane. As can be taken from the enlarged view in FIG. 2, the data packet forwarding unit 202 comprises a storage unit 202b configured to store at least one data transmission profiles, wherein each data transmission profile comprises at least one data packet forwarding rule, and a processor 202a configured to select a data transmission profile from the at least one data transmission profiles and to forward data packets within the data transmission network on the basis of the at least one data packet forwarding rule of the selected data transmission profile. In an embodiment, the processor 202a is configured to select the data transmission profile from the at least one data transmission profiles on the basis of a first control message from the controller 208 of the data transmission network 200. In an embodiment, the at least one data packet forwarding rule is stored in the storage unit 202b in the form of a flow table, a group table and/or a meter table.

In the present application a transmission profile or simply a profile is defined as a template any collection of flow rule(s) that are frequently used (together). A profile could be defined by the network administrator, a programmer or anyone that may believe that those set of rule will frequently be used together. A profile can specify a collection of flow rules that typically belong to, but is not limited to, the same protocol, same virtual network or a QoS class. The profile may store the generalized flow rule and may require specific arguments during invocation. For example a profile with a singular rule could look like: Match <ip_address> action: send to port <port_number>. Here the control node while loading the profile needs to specify the arguments: <ip_address> and <port_number> else the invocation is invalid. More example of more than one rule in a profile can be found in the present description.

The controller 208 is configured to control forwarding of data packets within a data transmission network by providing data packet forwarding rules to the data packet forwarding unit 202 as well as the other switches shown in FIG. 2. To this end, the controller 208 comprises a processor 208a configured to generate a first control message for the data packet forwarding unit 202, wherein the first control message instructs the data packet forwarding unit 202 to select a data transmission profile from the at least one data transmission profiles stored in the storage unit 202b of the data packet forwarding unit 202. In an embodiment, the controller 208 further comprises a storage unit 208b configured to store information about the at least one data transmission profiles of the data packet forwarding unit 202, i.e. information about which selectable data transmission profiles are available on the data packet forwarding unit 202. In the embodiment shown in FIG. 2, the controller 208 is configured to support at least one control applications 204a-c.

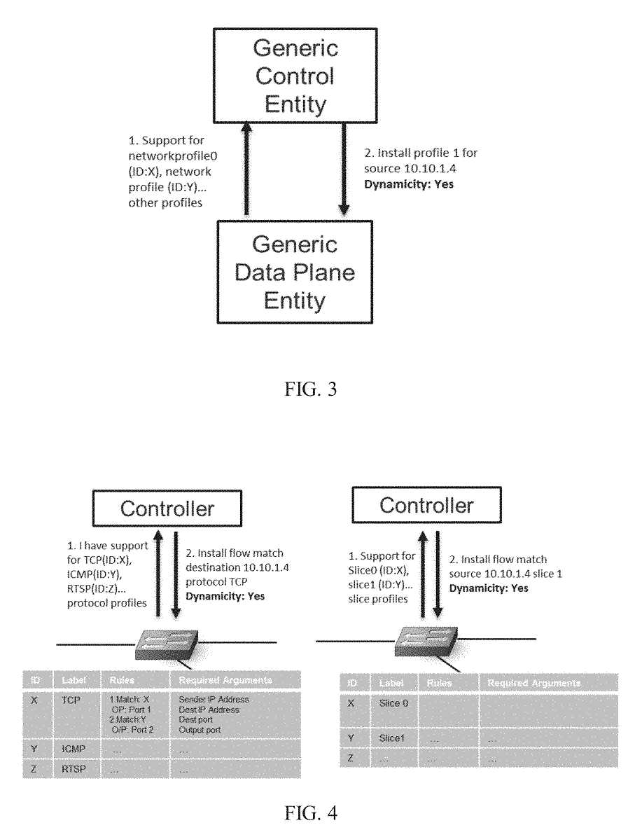

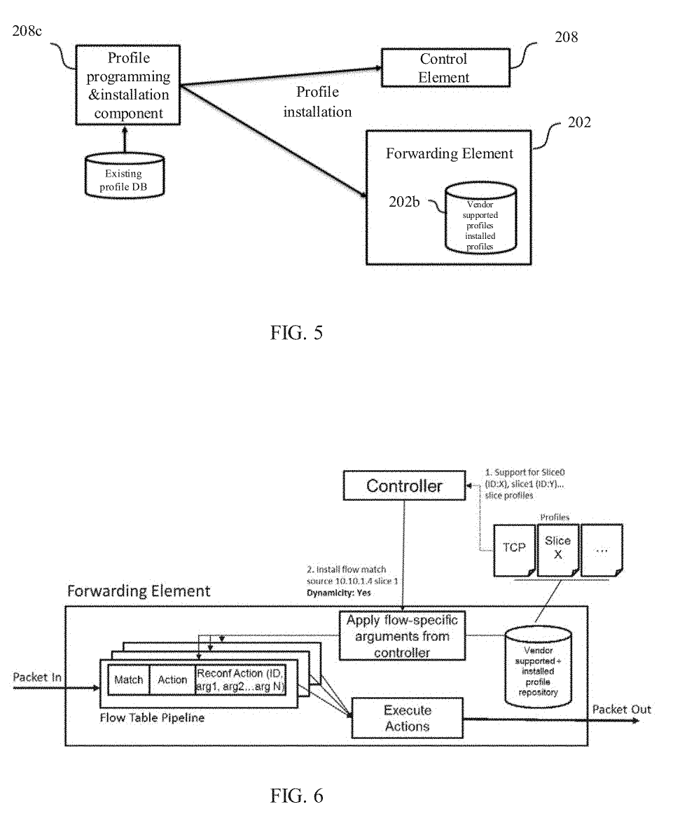

FIG. 3 shows a schematic diagram illustrating an interaction between the controller 208 according to an embodiment (i.e. the generic control plane entity) and the data packet forwarding unit 202 according to an embodiment (i.e. the generic data plane entity) according to an embodiment for a generic data transmission network. The controller 208 or another data plane entity can have access to a set of data transmission profiles, which can be stored, for instance, in a control plane database (see also FIG. 5). This enables the controller 208 to select a particular data transmission profile for a given connection. In the exemplary second step shown in FIG. 3, the controller 208 by means of a first control message selects to deploy a profile identified as “profile 1” for the IP address 10.10.1.4. In an embodiment, the first control message can include an identifier allowing the data packet forwarding unit 202 to select the data transmission profile identified by the identifier, e.g. “profile 1”. In an embodiment, the first control message can further comprise one or more parameters or arguments, such as the argument “Dynamicity: Yes” in the example shown in FIG. 3. In the exemplary first step shown in FIG. 3, the data packet forwarding unit 202 can inform the controller 208 about the data transmission profiles available on the data packet forwarding unit 202.

A more detailed version of the exemplary interaction between the controller 208 and the data packet forwarding unit 202 shown in FIG. 3 is shown in FIG. 4 for the case of a data transmission network in the form of a software-defined network (also referred to as slice or slices). In a corresponding first step, the data packet forwarding unit 202 can declare the types of profiles which it supports and are selectable by the SDN controller 208. In a corresponding second step, the SDN controller 208 can ask the data packet forwarding unit 202 to implement the flow rules (i.e. data packet forwarding rules) related to TCP for any given IP address source-destination pair, source or destination alone assuming known behaviour for those set of addresses. The detailed views in FIG. 4 show exemplary ways for storing the different data transmission profiles in the memory 202b of the data packet forwarding unit 202. As already described above, these data transmission profiles can be identified by an identifier, e.g. “X”, “Y”, “Z” and the like, labelled by a label, such as “TCP”, “ICMP”, “RTSP”, “Slice 0”, “Slice 1” and the like, and can comprise the corresponding data packet forwarding rules as well as any required parameters or arguments. The identifier of a data transmission profile is a sort of agreement between the SDN controller 208 and the data packet forwarding unit 202.

FIG. 5 shows a schematic diagram of a process to provide a data transmission profile to the data packet forwarding unit 202 according to an embodiment. The data transmission profiles in the data packet forwarding unit 202 can be standardised and initially deployed by the vendor of the data packet forwarding unit 202. Additional data transmission profiles can be deployed by the administrator or a programmer using a profile programming and installation component 208c as illustrated in FIG. 5. This component 208c can be a part of the controller 208 itself (or a separate component, as illustrated in FIG. 5) and it can use the interface between the controller 208 and the data packet forwarding unit 202, i.e. different control messages, to deploy the relevant data transmission profiles on the data packet forwarding unit 202. In an embodiment, the profiles are installed in such a way that both the controller 208 and the data packet forwarding unit 202 share a common reference to profile identifiers and profile parameters enabling the controller 208 to refer to a profile ID and specify the corresponding profile parameters. In an embodiment, the vendor based pre-installed profiles and other supported standardised profiles can be indicated to the controller 208 by the data packet forwarding unit 202 via the interface between the controller 208 and the data packet forwarding unit 202, i.e. different control messages. This can also apply to profiles, which are present on the controller 208, but not on the data packet forwarding unit 202. Furthermore, the controller 208 may learn these profiles from the data packet forwarding unis 202 and install them on other data packet forwarding units that initially did not contain those profiles.

In an embodiment, the controller 208 is configured to generate a second control message for the data packet forwarding unit 202, wherein the second control message instructs the data packet forwarding unit 202 to add a data packet forwarding rule to at least one of the data transmission profiles of the at least one data transmission profiles or to modify a data packet forwarding rule of at least one of the data transmission profiles of the at least one data transmission profiles on the basis of the second control message.

In an embodiment, the controller 208 is configured to generate a third control message for the data packet forwarding unit 202, wherein the third control message instructs the data packet forwarding unit 202 to add a data transmission profile to the at least one data transmission profiles on the basis of the third control message.

FIG. 6 shows a schematic diagram of the data packet forwarding unit 202 according to an embodiment and the controller 208 according to an embodiment. As already described above, in an embodiment the data packet forwarding unit 202 is a switch implemented in accordance with the OpenFlow standard and the at least one data packet forwarding rule is stored in the memory 202b of the switch 202 in the form of a flow table, a group table and/or a meter table. As the different operations indicated in FIG. 6 already have been described in the context of FIGS. 2 to 5 above, reference is made to the above description of FIGS. 2 to 5.

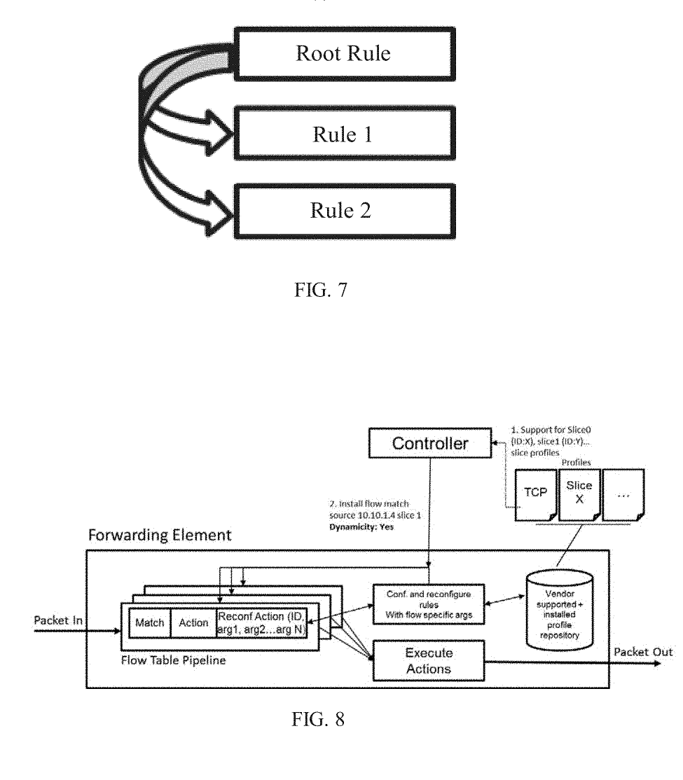

As illustrated in FIG. 6, when a match occurs, the switch 202 can perform the associated actions of the match. In an embodiment, this is a basic operation, which does not involve any dynamism. In other embodiments, however, the concept of dynamic flow rules dynamism can be implemented in the switch 202, as will be described in the following in the context of FIGS. 7 and 8, making the system extremely efficient and increasing the data plane elements flexibility.

FIG. 7 shows a schematic diagram illustrating the concept of dynamic flow rules implemented in the data packet forwarding unit 202 according to an embodiment. Using dynamic flow rules (DFR) enables the data packet forwarding unit 202 to change its forwarding behavior locally, according to predefined instructions set up by the controller 208.

Any given rule can be associated with a set of modifications that occur in the flow table when the rule is hit. For more details about implementing dynamic flow rules, which can be implemented in the data packet forwarding unit 202, reference is made to the PCT application PCT/EP2016/050549, which is herein incorporated by reference.

FIG. 8 shows a schematic diagram of the data packet forwarding unit 202 according to an embodiment implementing a dynamic flow rules (DFR) scheme. Due to the DFR scheme the controller 208 can pre-install various behaviors that can increase the efficiency of the operation of the switch 202 while reducing the load of the controller 208. For instance, when a transmission control protocol (TCP) FIN packet is matched, all rules related to that TCP connection can be deleted. In other words, in an embodiment, the selected data transmission profile can comprise a root data packet forwarding rule and at least one dependent data packet forwarding rule, wherein the processor 202a of the data packet forwarding unit 202 is configured to modify the at least one dependent data packet forwarding rule in response to the root data packet forwarding rule being used by the data packet forwarding unit 202 (i.e. in case of a match). The DFR scheme offloads the controller 208 processing and reduces the control signaling and related latency in case of the change of the local situation at the switch 202.

Similar to a data transmission profile, DFRs can have fixed match fields and “parameterizable” match fields. The parameterizable match fields can be changed by the SDN switch 202 by invoking so-called matched reconfigure actions. The reconfigure actions can include modification of the reconfigurable match fields, or modification/generation of associated data packet transmission rules. The pre-installed data transmission profile can be implemented as DFR itself The switch 202 can fill the parameters of the pre-installed profile template by itself according to the situation at the switch 202 when allowed by the controller 208. In this case, all the parameters of the pre-installed profile template can be seen as reconfigurable match fields in DFR.

An advantage deriving from using DFR is that complete slice or protocol behaviors can be programmed into the switch 202 alleviating the load of the controller 208. Furthermore, initially only the root rules need to be loaded. When the root rule is matched by an incoming packet the other rules may be loaded according to the specification of the profile.

This saves expensive ternary content-addressable (TCAM) memory space in the switch 202.

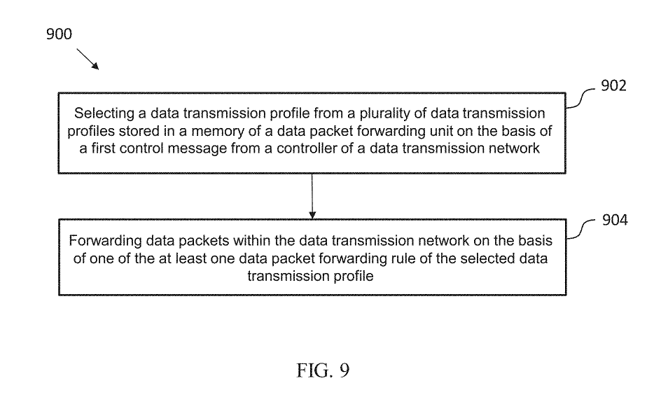

FIG. 9 shows a schematic diagram of a method 900 of operating the data packet forwarding unit 202 configured to forward data packets within a data transmission network on the basis of data packet forwarding rules, wherein the data transmission network comprises a control plane and a separate data plane. The method 900 comprises a first step 902 of selecting a data transmission profile from at least one data transmission profiles stored in the memory 202b of the data packet forwarding unit 202, wherein the data transmission profile comprises at least one data packet forwarding rule. The method 900 comprises a further step 904 of forwarding data packets within the data transmission network on the basis of one of the at least one data packet forwarding rule of the selected data transmission profile.

While a particular feature or aspect of the disclosure may have been disclosed with respect to only one of several implementations or embodiments, such feature or aspect may be combined with one or more other features or aspects of the other implementations or embodiments as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the embodiments of the invention beyond those described herein. While the present embodiments of the invention has been described with reference to one or more particular embodiments, those skilled in the art recognize that many changes may be made thereto without departing from the scope of the present embodiments of the invention. It is therefore to be understood that within the scope of the appended claims and their equivalents, the embodiments of the invention may be practiced otherwise than as specifically described herein.

What is claimed is:

1. A data packet forwarding unit configured to forward data packets within a data transmission network on the basis of data packet forwarding rules, wherein the data transmission network comprises a control plane and a separate data plane, wherein the data packet forwarding unit comprises:
a storage unit configured to store at least one of data transmission profiles, wherein each data transmission profile comprises at least one data packet forwarding rule; and
a processor configured to select a data transmission profile from the at least one data transmission profiles and to forward data packets within the data transmission network on the basis of the at least one data packet forwarding rule of the selected data transmission profile.

2. The data packet forwarding unit of claim 1, wherein the processor is configured to select the data transmission profile from the at least one data transmission profiles on the basis of a first control message from a controller of the data transmission network.

3. The data packet forwarding unit of claim 2, wherein the processor is configured to extract an identifier from the first control message and wherein the identifier identifies the selected data transmission profile.

4. The data packet forwarding unit of claim 2, wherein the processor is further configured to extract one or more parameters from the first control message to be applied to the selected data transmission profile.

5. The data packet forwarding unit of claim 1, wherein the processor is configured to add a data packet forwarding rule to at least one of the data transmission profiles of the at least one data transmission profiles or to modify or remove a data packet forwarding rule of at least one of the data transmission profiles of the at least one data transmission profiles on the basis of a second control message.

6. The data packet forwarding unit of claim 1, wherein the processor is configured to add a data transmission profile to the at least one data transmission profiles on the basis of a third control message.

7. The data packet forwarding unit of claim 1, wherein the data packet forwarding unit is a switch implemented in accordance with the OpenFlow standard and wherein the at least one data packet forwarding rule is stored in the storage unit in the form of a separate database, a flow table, a group table or a meter table.

8. The data packet forwarding unit of claim 1, wherein the data transmission network is a software defined network and wherein the controller of the data transmission network is a SDN controller.

9. The data packet forwarding unit of any one of claim 1, wherein the selected data transmission profile comprises a root data packet forwarding rule and at least one dependent data packet forwarding rule and wherein the processor is configured to activate or modify the at least one dependent data packet forwarding rule in response to the root data packet forwarding rule being used by the data packet forwarding unit.

10. The data packet forwarding unit of claim 1, wherein the data packet forwarding unit is configured to inform the controller of the data transmission network about the at least one data transmission profiles stored in the storage unit of the data packet forwarding unit.

11. A controller configured to control forwarding of data packets within a data transmission network by providing data packet forwarding rules to a data packet forwarding unit, wherein the data transmission network comprises a control plane and a separate data plane, wherein the controller comprises:
a processor configured to generate a first control message for the data packet forwarding unit, wherein the first control message instructs the data packet forwarding unit to select a data transmission profile from at least one of data transmission profiles of the data packet forwarding unit.

12. The controller of claim 11, wherein the processor is configured to generate a second control message for the data packet forwarding unit, wherein the second control message instructs the data packet forwarding unit to add a data packet forwarding rule to at least one of the data transmission profiles of the at least one data transmission profiles.

13. The controller of claim 11, wherein the processor is configured to generate a third control message for the data packet forwarding unit, wherein the third control message instructs the data packet forwarding unit to add a data transmission profile to the at least one data transmission profiles.

14. A method of operating a data packet forwarding unit configured to forward data packets within a data transmission network on the basis of data packet forwarding rules, wherein the data transmission network comprises a control plane and a separate data plane, wherein the method comprises:
selecting a data transmission profile from at least one data transmission profiles stored in a storage unit of the data packet forwarding unit, wherein the data transmission profile comprises at least one data packet forwarding rule; and
forwarding data packets within the data transmission network on the basis of one of the at least one data packet forwarding rule of the selected data transmission profile.
